(19) United States
(12) Patent Application Publication
(10) Pub. No.: US 2025/0063088 A1
(43) Pub. Date: Feb. 20, 2025

(54) METHODS FOR INTELLIGENT INFORMATION DOWNLOAD TO MULTIPLE BUILDING CONTROL DEVICES OVER A NETWORK

(71) Applicant: Honeywell International Inc., Charlotte, NC (US)

(72) Inventors: Ankita Kulkarni, Bengaluru (IN); Lavanya Bhadriraju, Bangalore (IN); Rajat Saha, Bangalore (IN); Ravi Bharathi Krishnan, Bangalore (IN); Shyamsundhar Madhusudhan, Chennai (IN)

(21) Appl. No.: 18/450,905

(22) Filed: Aug. 16, 2023

(51) Int. Cl. H04L 67/12; G05B 15/02

(52) U.S. Cl. CPC H04L 67/12; G05B 15/02

(57) ABSTRACT

Information may be downloaded to one or more of a plurality of building control devices over a network. A method includes identifying IDs of each of the plurality of building control devices to receive the downloaded information. The information that is to be downloaded is divided into a number of packets. Each of the packets are sequentially broadcast over the network, wherein the packets if received collectively download the information to each of the plurality of building control devices. Which, if any, of the plurality of building control devices that did not acknowledge receiving one or more of the packets, is identified. When one or more of the plurality of building control devices did not acknowledge receiving one or more of the packets, one or more unicast messages are sent over the network addressed to those building control devices.

### TECHNICAL FIELD

The present disclosure relates to methods and systems for performing software updates on building control devices and more particularly to methods and systems for efficiently performing software updates on multiple networked building control devices.

### BACKGROUND

Building control systems such as security systems, fire safety systems and HVAC (Heating, Ventilating and Air Conditioning) systems can include a large number of individual building control devices that periodically require software updates such as firmware updates. Updating one device at a time can consume a considerable amount of time, which can lead to some systems not being updated appropriately. What would be desirable are methods and system for updating a plurality of building control devices in parallel.

### SUMMARY

The present disclosure relates to methods and systems for performing software updates on building control devices and more particularly to methods and systems for efficiently performing software updates on multiple networked building control devices. An example may be found in a method for downloading information to one or more of a plurality of building control devices over a network, each of the plurality of building control devices including an ID that uniquely identifies the corresponding building control device. In some cases, the information may include a software update such as a firmware update. The illustrative method includes identifying the IDs of each of the plurality of building control devices that the information is to be downloaded. The information that is to be downloaded is divided into “n” parts, where “n” is an integer greater than one. Each of the “n” parts is assembled into a corresponding one of “n” broadcast messages, and each of the “n” broadcast messages includes the IDs that correspond to the one or more of the plurality of building control devices that the information is to be downloaded. Each of the “n” broadcast messages are sequentially broadcast over the network, wherein the “n” broadcast messages, if all received, collectively download the information to each of the plurality of building control devices that the information is to be downloaded. The method includes identifying which, if any, of the plurality of building control devices that the information is to be downloaded to did not acknowledge receiving one or more of the “n” broadcast messages. When one or more of the plurality of building control devices that the information is to be downloaded did not acknowledge receiving one or more of the “n” broadcast messages, the method includes sending one or more unicast messages over the network addressed to each of those building control devices that did not acknowledge receiving one or more of the “n” broadcast messages, wherein the one or more unicast messages are configured to communicate the information that was not received by the corresponding building control device via the “n” broadcast messages.

Another example may be found in a software update tool for downloading a software update to one or more of a plurality of building control devices over a network. The software update tool includes a user interface, a port operatively coupled to the network, and a controller operatively coupled to the user interface and the port. The controller is configured to receive via the user interface a selection of each of one or more of the plurality of building control devices that is to receive the software update, wherein each of the plurality of building control devices include an ID that uniquely identifies the corresponding building control device on the network. The controller is configured to divide the software update that is to be downloaded into “n” parts, where “n” is an integer greater than one. Each of the “n” parts is assembled into a corresponding one of “n” broadcast messages, and wherein each of the “n” broadcast messages includes the IDs that correspond to the selected one or more of the plurality of building control devices that is to receive the software updated. The controller is configured to sequentially broadcast each of the “n” broadcast messages over the network, wherein the “n” broadcast messages, if all are received, collectively download the software update to each of the selected one or more of the plurality of building control devices that is to receive the software update. The controller is configured to identify which, if any, of the selected one or more of the plurality of building control devices that is to receive the software update did not acknowledge receiving one or more of the “n” broadcast messages, and when one or more of the selected one or more of the plurality of building control devices that is to receive the software update did not acknowledge receiving one or more of the “n” broadcast messages, the controller is configured to send one or more unicast messages over the network addressed to each of those selected building control devices that did not acknowledge receiving one or more of the “n” broadcast messages, where the one or more unicast messages are configured to communicate the portion of the software update that was not received by the corresponding building control device via the “n” broadcast messages.

Another example may be found in a non-transitory computer readable medium storing instructions thereon that when executed by one or more processors cause the one or more processors to receive an ID for each of a plurality of building control devices on a network to which a software update is desired, divide the software update into “n” parts, where “n” is an integer greater than one, and assemble each of the “n” parts into a corresponding one of “n” broadcast messages, wherein each of the “n” broadcast messages includes the IDs of the building control devices that the software updated is desired. The one or more processors are caused to sequentially broadcast each of the “n” broadcast messages over the network, wherein the “n” broadcast messages, if all are received, collectively download the software update to each of the plurality of building control devices with an ID that matches one of the IDs in the corresponding broadcast message. The one or more processors are caused to identify which, if any, of the plurality of building control devices with a matching ID did not acknowledge receiving one or more of the “n” broadcast messages, and when one or more of the plurality of building control devices with a matching ID did not acknowledge receiving one or more of the “n” broadcast messages, the one or more processors are caused to send one or more unicast messages over the network addressed to each of those building control devices with a matching ID that did not acknowledge receiving one or more of the “n” broadcast messages, where the one or more unicast messages communicate the portion of the software update that was not received by the corresponding building control device via the “n” broadcast messages.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram of an illustrative software update tool shown in context within a building control system;

FIGS. 2A and 2B are flow diagrams that together show an illustrative method for downloading information to one or more of a plurality of building control devices over a network;

FIGS. 3A and 3B are flow diagrams that together show an illustrative method; and

FIG. 4 is a schematic block diagram of an illustrative building control system.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

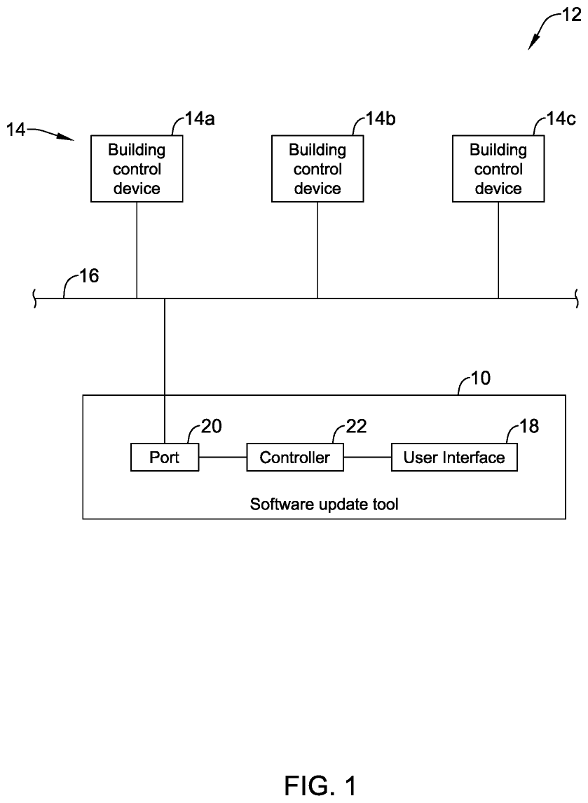

FIG. 1 is a schematic block diagram showing an illustrative software update tool 10, shown in context with part of an illustrative building control system 12. The illustrative building control system 12 may represent any of a security system, a fire safety system, an HVAC (Heating, Ventilating and Air Conditioning) system, a lighting system and/or any other suitable building control system. The building control system 12 includes a number of building control devices 14, individually labeled as 14a, 14b and 14c. While three building control devices 14 are shown, this is merely illustrative, as the building control system 12 may include any number of building control devices 14. If the building control system 12 represents a security system, the building control devices 14 may represent components of a security system. If the building control system 12 represents a fire safety system, the building control devices 14 may represent components of a fire safety system. If the building control system 12 represents an HVAC system, the building control devices 14 may represent components of an HVAC system. The building control devices 14 may include firmware and/or other software that controls operation of each building control device 14. In some cases, the firmware and/or other software may include data or other information referenced by the firmware and/or other software logic. In some cases, the firmware and/or other software may include configuration settings that are referenced by the firmware and/or other software logic. These are just examples.

The building control devices are operably coupled with a network 16. The network 16 may represent a wired network. In some instances, the network 16 may represent a BACnet or Modbus communication network. While not shown, other components of the building control system 12, such as a plant controller, may also be operably coupled with the network 16 and thus may be in communication with the building control devices 14. In some instances, the network 16 may be a wired network that allows each building control device 14 to communicate with a building control device 14 either immediately upstream or immediately downstream of the building control device 14. In some instances, the network 16 may be a wireless network, communicating via any of a plurality of different wireless communication protocols. In some instances, the building control devices 14 may communicate with each via a wireless mesh communications network, for example.

The software update tool 10 may be used for updating the firmware within at least some of the building control devices 14. In some instances, the software update tool 10 may be configured for downloading a software update to one or more of the building control devices 14 over the network 16. The illustrative software update tool 10 includes a user interface 18, a port 20 that is configured to be operatively coupled to the network 16, and a controller 22 that is operably coupled to the user interface 18 and to the port 20. The controller 22 is configured to receive via the user interface 18 a selection of each of one or more of the plurality of building control devices 14 that are to receive the software update, wherein each of the plurality of building control devices 14 include an ID that uniquely identifies the corresponding building control device 14 on the network. The controller 22 is configured to divide the software update that is to be downloaded into “n” parts, where “n” is an integer greater than one, wherein each of the “n” parts is assembled into a corresponding one of “n” broadcast messages, and wherein each of the “n” broadcast messages includes the IDs that correspond to the selected one or more of the plurality of building control devices 14 that are to receive the software update.

The controller 22 is configured to sequentially broadcast each of the “n” broadcast messages over the network 16, wherein the “n” broadcast messages, if received, collectively download the software update to each of the selected one or more of the plurality of building control devices 14 that are to receive the software update. The controller 22 is configured to identify which, if any, of the selected one or more of the plurality of building control devices 14 that are to receive the software update did not acknowledge receiving one or more of the “n” broadcast messages. When one or more of the selected one or more of the plurality of building control devices that was to receive the software update did not acknowledge receiving one or more of the “n” broadcast messages, the controller 22 is configured to send one or more unicast messages over the network 16 addressed to each of those selected building control devices 14 that did not acknowledge receiving one or more of the “n” broadcast messages, wherein the one or more unicast messages are configured to communicate the portion of the software update that was not received by the corresponding building control device 14 via the “n” broadcast messages. In some cases, the one or more unicast messages are configured to communicate only the portion of the software update that was not received by the corresponding building control device 14 via the “n” broadcast messages.

In some instances, when one or more of the selected one or more of the plurality of building control devices that was to receive the software update did not acknowledge receiving one or more of the “n” broadcast messages, the controller 22 is configured to retry sending one or more of the “n” broadcast messages over the network 16 before sending the one or more unicast messages to see whether one or more of the selected building control devices 14 that did not acknowledge receiving one or more of the “n” broadcast messages indicates receiving one or more of the retry broadcast messages. In some instances, when one or more of the selected one or more of the plurality of building control devices 14 that did not acknowledge receiving one or more of the “n” broadcast messages indicates receiving one or more of the retry broadcast messages, the controller 22 may be configured to not send one or more of the unicast messages over the network that communicate the portion of the software update that was received via the one or more of the retry broadcast messages. In some instances, when one or more of the selected one or more of the plurality of building control devices 14 that are to receive the software update did not acknowledge receiving one or more of the “n” broadcast messages, the controller 22 may be configured to retry sending one or more of the “n” broadcast messages over the network 16 a plurality of times before sending one or more unicast messages to see whether one or more of the selected building control devices 14 that did not acknowledge receiving one or more of the “n” broadcast messages indicates receiving one or more of the plurality of retry broadcast messages.

In some instances, each of the selected one or more of the plurality of building control devices 14 may process each of the “n” broadcast messages after receiving the corresponding broadcast message. In some instances, each of the selected one or more of the plurality of building control devices 14 that received one of the “n” broadcast messages may be programmed to ignore and not re-process a retry of the corresponding broadcast messages.

In some instances, for each of the “n” broadcast messages, each of the selected one or more of the plurality of building control devices 14 that are to receive the software update stores at least temporally a table that identifies which of the selected one or more of the plurality of building control devices 14 that are to receive the software update did not acknowledge receiving each of the “n” broadcast message. In some instances, for each of the “n” broadcast messages, at least one of the selected one or more of the plurality of building control devices 14 that are to receive the software update reports over the network 16 which of the selected one or more of the plurality of building control devices 14 that are to receive the software update did not acknowledge receiving the corresponding “n” broadcast message. In some instances, the one or more unicast messages are configured to communicate the portion of the software update that was not received by the corresponding building control device 14 via the “n” broadcast messages, but does not communicate a portion of the software update that was received by the corresponding building control device 14 via the “n” broadcast messages.

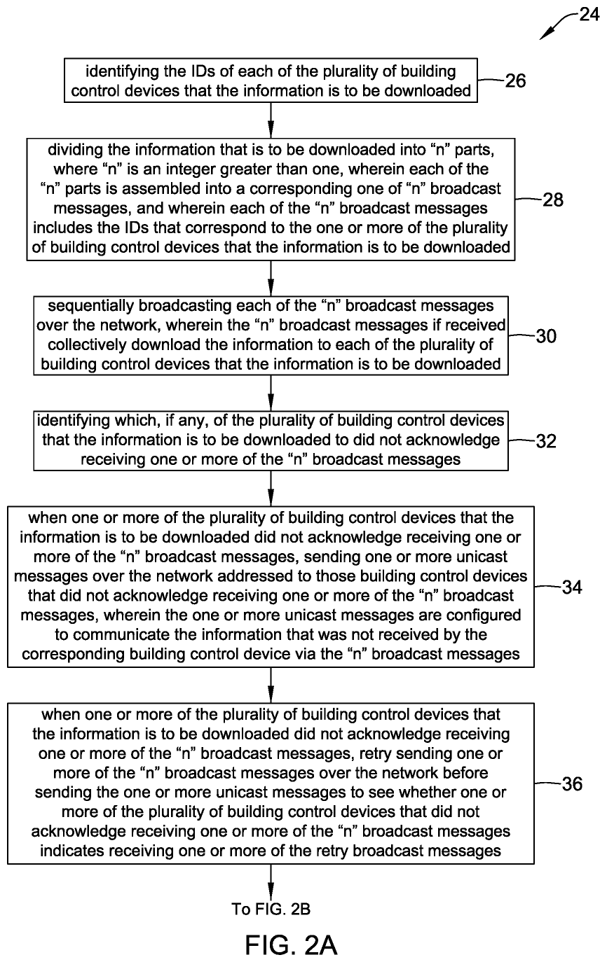

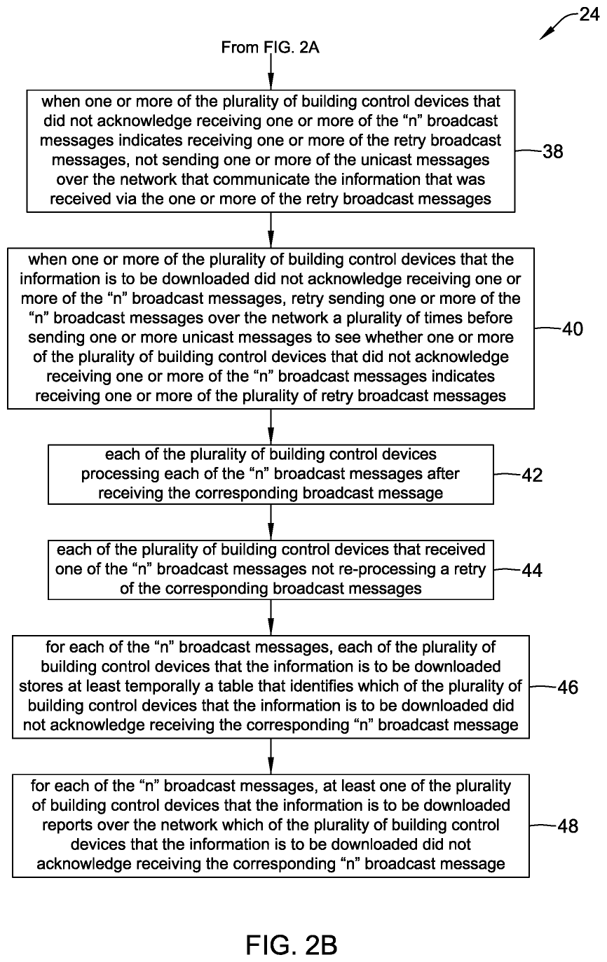

FIGS. 2A and 2B are flow diagrams that together show an illustrative method 24 for downloading information to one or more of a plurality of building control devices (such as the building control devices 14) over a network (such as the network 16). Each of the plurality of building control devices including an ID that uniquely identifies the corresponding building control device on the network. The method 24 includes identifying the IDs of each of the plurality of building control devices that the information is to be downloaded, as indicated at block 26. The information that is to be downloaded is divided into “n” parts, where “n” is an integer greater than one. Each of the “n” parts is assembled into a corresponding one of “n” broadcast messages, and wherein each of the “n” broadcast messages includes the IDs that correspond to the one or more of the plurality of building control devices that the information is to be downloaded, as indicated at block 28. Each of the “n” broadcast messages are sequentially broadcast over the network, wherein the “n” broadcast messages, if received, collectively download the information to each of the plurality of building control devices that the information is to be downloaded, as indicated at block 30. The method 24 includes identifying which, if any, of the plurality of building control devices that the information is to be downloaded to did not acknowledge receiving one or more of the “n” broadcast messages, as indicated at block 32. When one or more of the plurality of building control devices that the information is to be downloaded did not acknowledge receiving one or more of the “n” broadcast messages, one or more unicast messages are sent over the network addressed to each of those building control devices that did not acknowledge receiving one or more of the “n” broadcast messages, wherein the one or more unicast messages are configured to communicate the information that was not received by the corresponding building control device via the “n” broadcast messages, as indicated at block 34. In some instances, when one or more of the plurality of building control devices that the information is to be downloaded did not acknowledge receiving one or more of the “n” broadcast messages, the method 24 includes retrying to send one or more of the “n” broadcast messages over the network before sending the one or more unicast messages to see whether one or more of the plurality of building control devices that did not acknowledge receiving one or more of the “n” broadcast messages indicates receiving one or more of the retry broadcast messages, as indicated at block 36.

Continuing on FIG. 2B, in some instances, the method 24 may include when one or more of the plurality of building control devices that did not acknowledge receiving one or more of the “n” broadcast messages indicates receiving one or more of the retry broadcast messages, the method does not send one or more of the unicast messages over the network that communicate the information that was received via the one or more of the retry broadcast messages, as indicated at block 38. In some instances, when one or more of the plurality of building control devices that the information is to be downloaded did not acknowledge receiving one or more of the “n” broadcast messages, the method includes retry sending one or more of the “n” broadcast messages over the network a plurality of times before sending one or more unicast messages to see whether one or more of the plurality of building control devices that did not acknowledge receiving one or more of the “n” broadcast messages indicates receiving one or more of the plurality of retry broadcast messages, as indicated at block 40.

In some instances, each of the plurality of building control devices may process each of the “n” broadcast messages after receiving the corresponding broadcast message, as indicated at block 42. In some instances, each of the plurality of building control devices that received one of the “n” broadcast messages ignore and do not re-process a retry of the corresponding broadcast messages, as indicated at block 44. In some instances, for each of the “n” broadcast messages, each of the plurality of building control devices that the information is to be downloaded stores at least temporally a table that identifies which of the plurality of building control devices that the information is to be downloaded did not acknowledge receiving the corresponding “n” broadcast message, as indicated at block 46. In some instances, for each of the “n” broadcast messages, at least one of the plurality of building control devices that the information is to be downloaded reports over the network which of the plurality of building control devices that the information is to be downloaded did not acknowledge receiving the corresponding “n” broadcast message, as indicated at block 48. This may be used to determine which broadcast messages were not properly downloaded to which of the plurality of building control devices, if any, and may be used to determine what which parts of the information needs to be provided to which of the plurality of building control devices via the unicast messages across the network.

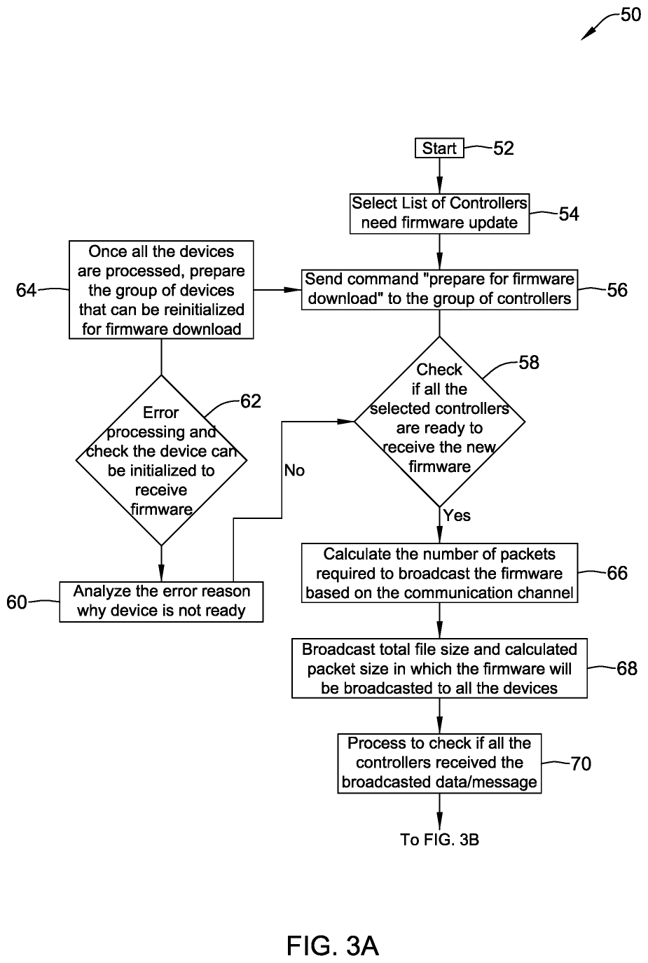

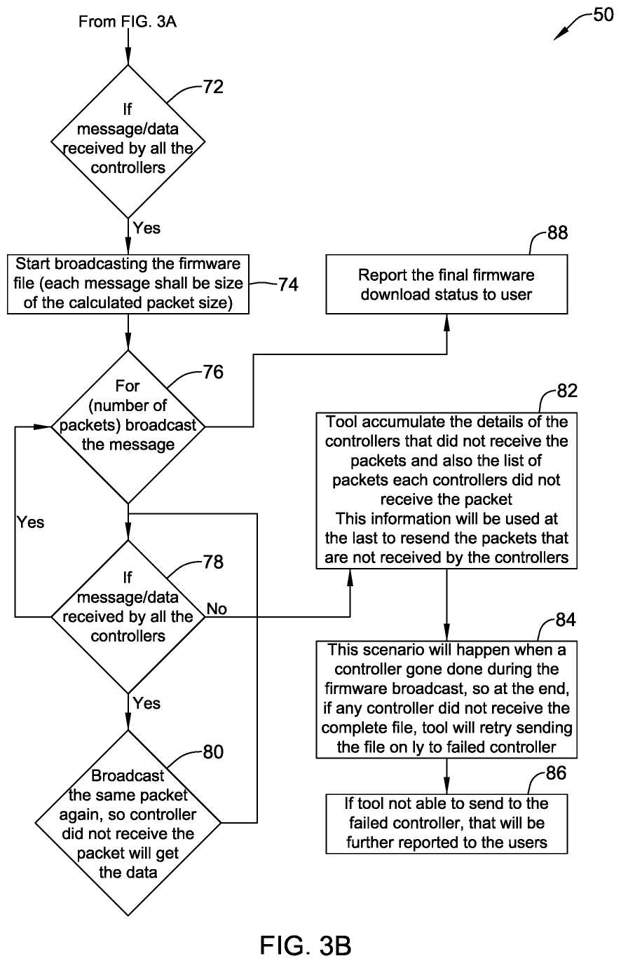

FIGS. 3A and 3B are flow diagrams that together show an illustrative method 50. The illustrative method 50 begins at a start block 52. From there, control passes to block 54, where a controllers needing a firmware update are selected. A command is sent across a network to those controllers instructing them to prepare for a firmware update, as indicated at block 56. At a decision block 58, a determination is made as to whether all of the selected controllers are ready to receive the firmware update. If not, control passes to block 60, where an analysis is performed as to why one or more controllers are not ready to receive the firmware update. At a decision block 62, a determination is made as to whether the one or more controllers can be reinitialized in order to receive the firmware update. If so, that controller is added to a group to be reinitialized. Control then passes to block 64, and the group of controllers are reinitialized. From there, control reverts to block 56.

If at decision block 58 the answer is yes, control passes to block 66, where a number of packets needed to broadcast the firmware update is calculated. The total file size and calculated packet size is broadcast to all of the devices, as indicated at block 68. A check is made as to whether each of the controllers received the broadcast message, as indicated at block 70.

The method 50 continues on FIG. 3B, where a determination is made at a decision block 72 as to whether each of the controllers received the broadcast message. If so, control passes to block 74 and sequential broadcast of the packets begins. At a decision block 76, a determination is made as to whether all of the packets have been broadcast yet. If not, control passes to a decision block 78, where a determination is made as to whether the message was received by all intended controllers. If so, control reverts to block 72 and the next message is broadcast. If not, control passes to block 80, where the message is re-broadcast several times. In some instances, the message is re-broadcast three times. From decision block 78, if the answer is no, control also passes to block 82, where the tool accumulates the details of the controllers that did not receive all packets, as well as which packets were not received by each controller. Control passes to block 84, where the tool will attempt to send unicast messages directly to each controller that did not receive all of the broadcast messages. The unicast messages sending only those packets of the firmware update that were not being received by the corresponding controller via the broadcast messages. If the unicast messages are unsuccessful, this will be reported to the user, as indicated at block 86. Returning to decision block 76, if the answer is yes, control passes to block 88, where the final update status is reported to the user.

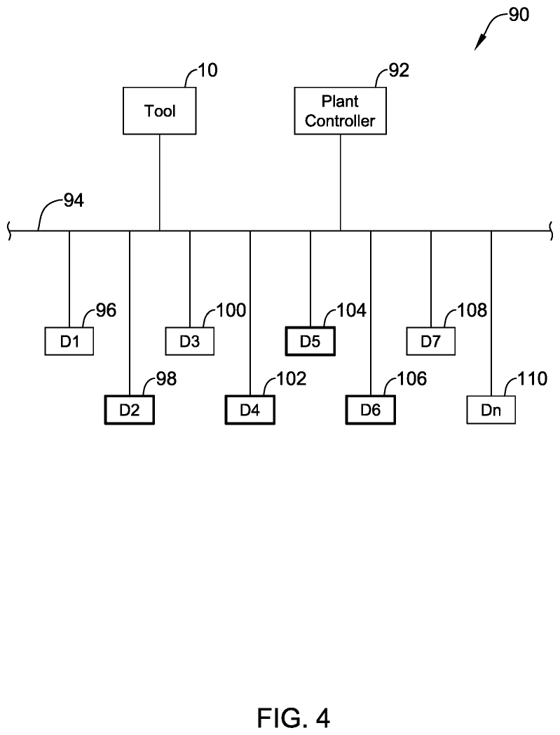

FIG. 4 is a schematic block diagram showing an illustrative building control system 90. The building control system 90 may be considered as being an example of the building control system 12 shown in FIG. 1. The building control system 90 includes a plant controller 92 that may monitor and control various operations of the building control system 90. The plant controller 92 and the software update tool 10 (FIG. 1) are operably coupled with a network 94. The network 94, which may be considered as being an example of the network 16, may be a wired network, a wireless network or a combination of a wired and wireless network. The building control system 90 includes a number of nodes 96, 98, 100, 102, 104, 106, 108 and 110. “N” nodes D1, D2 through Dn are shown, where “N” is a positive integer. In some instances, each node represents a building control device. Each of the nodes 96, 98, 100, 102, 104, 106, 108 and 110 may be seen as being operably coupled to the network 94, and hence are communicatively coupled with the software update tool 10. The software update tool 10 is shown directly connected to the network 94. However, in some cases, the software update tool 10 may be operatively coupled to the network 94 through the plant controller 92 or some other device (e.g. a gateway, firewall, etc.).

While there is a total of eight nodes 96, 98, 100, 102, 104, 106, 108 and 110 shown, some of these nodes are selected to receive a particular firmware update and others are not selected. As shown, the nodes 98 (D2), 102 (D4), 104 (D5) and 106 (D6) are highlighted as being selected while the nodes 96 (D1), 100 (D3), 108 (D7) and 110 (Dn) have not been selected. This means that the nodes 98 (D2), 102 (D4), 104 (D5) and 106 (D6) will be participating in a firmware update process while the nodes 96 (D1), 100 (D3), 108 (D7) and 110 (Dn) will not be.

To begin, the software update tool 10, after initializing the nodes 98 (D2), 102 (D4), 104 (D5) and 106 (D6) for a firmware update, will broadcast a firmware packet #1 on the network 94 identifying each pf the participating nodes 98 (D2), 102 (D4), 104 (D5) and 106 (D6), and waits for the corresponding acknowledgement messages from each of the participating nodes 98 (D2), 102 (D4), 104 (D5) and 106 (D6). The nodes 98 (D2), 102 (D4), 104 (D5) and 106 (D6) will receive the firmware packet #1 and will each process the firmware packet #1 (e.g. uncompress, descript, checksum, etc.). The nodes 96 (D1), 100 (D3), 108 (D7) and 110 (Dn) will ignore the firmware packet #1. When each node 98 (D2), 102 (D4), 104 (D5) and 106 (D6) successfully processes the firmware packet #1, each node will broadcast a “done” message along with its ID to confirm successful receipt of the firmware packet #1. Each node will maintain a lookup-table of nodes, showing which of the participating nodes successfully processed the firmware packet #1 and broadcast their “done” message. Every participating node that sees the “done” broadcast (with the corresponding ID) will update its own look-up table of nodes. When the last participating node successfully processes the firmware packet #1 (say the node 106 (D6) in this case), that participating node will broadcast its look-up node to the software update tool 10. Once the software update tool 10 receives this message, the software update tool 10 will broadcast the firmware packet #2, and so on.

In some instances, one or more of the participating nodes may not successfully receive one of the firmware packets, and may not broadcast its “done” message (and its corresponding ID). Let's say that the node 98 (D2) does not receive the firmware packet #1, and does not broadcasts its “done” message in response to the firmware packet #1. As a result, the look-up table stored in each of the other participating nodes, and in particular the look-up table stored in the participating node last to receive and process the firmware packet #1, will be broadcast its table to the software update tool 10 showing that node 98 (D2) did not properly receive firmware packet #1. The software update tool 10 will realize that the node 98 (D2) did not properly receive the firmware packet #1, and in response will rebroadcast the firmware packet #1. The node 98 (D2) will recognize that the node 98 (D2) has not yet successfully received the firmware packet #1, and thus will process the duplicate firmware packet #1. The remaining participating nodes 102 (D4), 104 (D5) and 106 (D6), which each successfully received the first broadcast of the firmware packet #1, will ignore the duplicate retry broadcast. The nodes 96 (D1), 100 (D3), 108 (D7) and 110 (Dn) will also ignore the duplicate retry broadcast of the firmware packet #1 as well.

In some instances, one or more of the participating nodes 98 (D2), 102 (D4), 104 (D5) and 106 (D6) may not receive one or more firmware packet and a rebroadcast of firmware packet, but may receive other of the firmware packets. This may occur when, for example, a participating node goes momentary offline, or otherwise has a momentary disruption. When this occurs, the software update tool 10 may identify which firmware packets were not received by which of the participating nodes (e.g. via the look-up tables received), and send unicast messages on the network that deliver the missing firmware packets to the appropriate participating nodes.

In some instances, one or more of the participating nodes 98 (D2), 102 (D4), 104 (D5) and 106 (D6) may not receive all or a majority of the firmware packets and the rebroadcast of the firmware packets, such as when the participating node is in a hung state, powered down or otherwise offline during the firmware update. If for example the node 106 (D6) is offline during the update, this will show up in the look-up tables broadcast to the software update tool 10 after each firmware packet has been broadcast. Once the firmware update is complete, the software update tool 10 will check to see if the node 106 (D6) has come back online. If so, the software update tool 10 will download the firmware update just to the node 106 (D6), such as via a unicast message. If the node 106 (D6) remains offline, the software update tool 10 will report this failure so that corrective action may be taken with respect to fixing or replacing the node 106 (D6).

Once all of the firmware packets are received by each of the participating node 98 (D2), 102 (D4), 104 (D5) and 106 (D6), each participating node 98 (D2), 102 (D4), 104 (D5) and 106 (D6) assembles the packets into a firmware upgrade executable, and executes the firmware upgrade executable to update the firmware of the respective device.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for downloading information to one or more of a plurality of building control devices over a network, each of the plurality of building control devices including an ID that uniquely identifies the corresponding building control device, the method comprising:
identifying the IDs of each of the plurality of building control devices that the information is to be downloaded;
dividing the information that is to be downloaded into “n” parts, where “n” is an integer greater than one, wherein each of the “n” parts is assembled into a corresponding one of “n” broadcast messages, and wherein each of the “n” broadcast messages includes the IDs that correspond to the one or more of the plurality of building control devices that the information is to be downloaded;
sequentially broadcasting each of the “n” broadcast messages over the network, wherein the “n” broadcast messages if received collectively download the information to each of the plurality of building control devices that the information is to be downloaded;
identifying which, if any, of the plurality of building control devices that the information is to be downloaded to did not acknowledge receiving one or more of the “n” broadcast messages; and
when one or more of the plurality of building control devices that the information is to be downloaded did not acknowledge receiving one or more of the “n” broadcast messages, sending one or more unicast messages over the network addressed to each of those building control devices that did not acknowledge receiving one or more of the “n” broadcast messages, wherein the one or more unicast messages are configured to communicate the information that was not received by the corresponding building control device via the “n” broadcast messages.

2. The method of claim 1, wherein when one or more of the plurality of building control devices that the information is to be downloaded did not acknowledge receiving one or more of the “n” broadcast messages, retry sending one or more of the “n” broadcast messages over the network before sending the one or more unicast messages to see whether one or more of the plurality of building control devices that did not acknowledge receiving one or more of the “n” broadcast messages indicates receiving one or more of the retry broadcast messages.

3. The method of claim 2, wherein when one or more of the plurality of building control devices that did not acknowledge receiving one or more of the “n” broadcast messages indicates receiving one or more of the retry broadcast messages, not sending one or more of the unicast messages over the network that communicate the information that was received via the one or more of the retry broadcast messages.

4. The method of claim 1, wherein when one or more of the plurality of building control devices that the information is to be downloaded did not acknowledge receiving one or more of the “n” broadcast messages, retry sending one or more of the “n” broadcast messages over the network a plurality of times before sending one or more unicast messages to see whether one or more of the plurality of building control devices that did not acknowledge receiving one or more of the “n” broadcast messages indicates receiving one or more of the plurality of retry broadcast messages.

5. The method of claim 1, wherein each of the plurality of building control devices processing each of the “n” broadcast messages after receiving the corresponding broadcast message.

6. The method of claim 5, wherein each of the plurality of building control devices that received one of the “n” broadcast messages not re-processing a retry of the corresponding broadcast messages.

7. The method of claim 1, where for each of the “n” broadcast messages, each of the plurality of building control devices that the information is to be downloaded stores at least temporally a table that identifies which of the plurality of building control devices that the information is to be downloaded did not acknowledge receiving the corresponding “n” broadcast message.

8. The method of claim 7, wherein for each of the “n” broadcast messages, at least one of the plurality of building control devices that the information is to be downloaded reports over the network which of the plurality of building control devices that the information is to be downloaded did not acknowledge receiving the corresponding “n” broadcast message.

9. A software update tool for downloading a software update to one or more of a plurality of building control devices over a network, the software update tool comprising:
a user interface;
a port operatively coupled to the network;
a controller operatively coupled to the user interface and the port, the controller configured to:
receive via the user interface a selection of each of one or more of the plurality of building control devices that is to receive the software update, wherein each of the plurality of building control devices include an ID that uniquely identifies the corresponding building control device;
divide the software update that is to be downloaded into “n” parts, where “n” is an integer greater than one, wherein each of the “n” parts is assembled into a corresponding one of “n” broadcast messages, and wherein each of the “n” broadcast messages includes the IDs that correspond to the selected one or more of the plurality of building control devices that is to receive the software updated;
sequentially broadcasting each of the “n” broadcast messages over the network, wherein the “n” broadcast messages if received collectively download the software update to each of the selected one or more of the plurality of building control devices that is to receive the software update;
identifying which, if any, of the selected one or more of the plurality of building control devices that is to receive the software update did not acknowledge receiving one or more of the “n” broadcast messages; and
when one or more of the selected one or more of the plurality of building control devices that is to receive the software update did not acknowledge receiving one or more of the “n” broadcast messages, sending one or more unicast messages over the network addressed to each of those selected building control devices that did not acknowledge receiving one or more of the “n” broadcast messages, wherein the one or more unicast messages are configured to communicate the portion of the software update that was not received by the corresponding building control device via the “n” broadcast messages.

10. The software update tool of claim 9, wherein when one or more of the selected one or more of the plurality of building control devices that is to receive the software update did not acknowledge receiving one or more of the “n” broadcast messages, retry sending one or more of the “n” broadcast messages over the network before sending the one or more unicast messages to see whether one or more of the selected one or more of the plurality of building control devices that did not acknowledge receiving one or more of the “n” broadcast messages indicates receiving one or more of the retry broadcast messages.

11. The software update tool of claim 10, wherein when one or more of the selected one or more of the plurality of building control devices that did not acknowledge receiving one or more of the “n” broadcast messages indicates receiving one or more of the retry broadcast messages, not sending one or more of the unicast messages over the network that communicate the portion of the software update that was received via the one or more of the retry broadcast messages.

12. The software update tool of claim 9, wherein when one or more of the selected one or more of the plurality of building control devices that is to receive the software update did not acknowledge receiving one or more of the “n” broadcast messages, retry sending one or more of the “n” broadcast messages over the network a plurality of times before sending one or more unicast messages to see whether one or more of the selected one or more of the plurality of building control devices that did not acknowledge receiving one or more of the “n” broadcast messages indicates receiving one or more of the plurality of retry broadcast messages.

13. The software update tool of claim 9, wherein each of the selected one or more of the plurality of building control devices processing each of the “n” broadcast messages after receiving the corresponding broadcast message.

14. The software update tool of claim 13, wherein each of the selected one or more of the plurality of building control devices that received one of the “n” broadcast messages not re-processing a retry of the corresponding broadcast messages.

15. The software update tool of claim 9, where for each of the “n” broadcast messages, each of the selected one or more of the plurality of building control devices that is to receive the software update stores at least temporally a table that identifies which of the selected one or more of the plurality of building control devices that is to receive the software update did not acknowledge receiving the corresponding “n” broadcast message.

16. The software update tool of claim 15, wherein for each of the “n” broadcast messages, at least one of the selected one or more of the plurality of building control devices that is to receive the software update reports over the network which of the selected one or more of the plurality of building control devices that is to receive the software update did not acknowledge receiving the corresponding “n” broadcast message.

17. The software update tool of claim 9, wherein the one or more unicast messages are configured to communicate the portion of the software update that was not received by the corresponding building control device via the “n” broadcast messages, but does not communicate a portion of the software update that was received by the corresponding building control device via the “n” broadcast messages.

18. A non-transitory computer readable medium storing instructions thereon that when executed by one or more processors cause the one or more processors to:
receive an ID for each of a plurality of building control devices on a network to which a software update is desired;
dividing the software update into “n” parts, where “n” is an integer greater than one, wherein each of the “n” parts is assembled into a corresponding one of “n” broadcast messages, and wherein each of the “n” broadcast messages includes the IDs;
sequentially broadcasting each of the “n” broadcast messages over the network, wherein the “n” broadcast messages if received collectively download the software update to each of the plurality of building control devices with an ID that matches one of the IDs in the corresponding broadcast message;
identifying which, if any, of the plurality of building control devices with a matching ID that did not acknowledge receiving one or more of the “n” broadcast messages; and
when one or more of the plurality of building control devices with a matching ID did not acknowledge receiving one or more of the “n” broadcast messages, sending one or more unicast messages over the network addressed to each of those building control devices with a matching ID that did not acknowledge receiving one or more of the “n” broadcast messages, wherein the one or more unicast messages communicate the portion of the software update that was not received by the corresponding building control device via the “n” broadcast messages.

19. The non-transitory computer readable medium of claim 18, wherein when one or more of the plurality of building control devices with a matching ID that did not acknowledge receiving one or more of the “n” broadcast messages, retry sending one or more of the “n” broadcast messages over the network before sending the one or more unicast messages to see whether one or more of the plurality of building control devices with a matching ID that did not acknowledge receiving one or more of the “n” broadcast messages indicates receiving one or more of the retry broadcast messages.

20. The non-transitory computer readable medium of claim 19, wherein when one or more of the plurality of building control devices with a matching ID that did not acknowledge receiving one or more of the “n” broadcast messages indicates receiving one or more of the retry broadcast messages, not sending one or more of the unicast messages over the network that communicate the portion of the software update that was received via the one or more of the retry broadcast messages.
